(19) United States
(12) Patent Application Publication
(10) Pub. No.: US 2016/0186678 A1
(43) Pub. Date: Jun. 30, 2016

(54) TWO-STAGE TURBO CHARGER SYSTEM AND METHOD OF CONTROLLING THE SAME

(71) Applicant: HYUNDAI MOTOR COMPANY, Seoul (KR)

(72) Inventors: Kyoung HEO, Anyang-si (KR); You Sang SON, Suwon-si (KR)

(21) Appl. No.: 14/944,027

(22) Filed: Nov. 17, 2015

(30) Foreign Application Priority Data
Dec. 24, 2014 (KR) 10-2014-0188626

(51) Int. Cl. F02D 41/00; F02D 41/04; F02B 37/16; F02B 37/18; F02B 33/40; F02B 37/013

(52) U.S. Cl. CPC F02D 41/0007; F02B 33/40; F02B 37/013; F02B 37/16; F02B 37/183; F02D 41/045

(57) ABSTRACT

A two-stage turbo charger system includes: a high pressure turbine driven by exhaust gas from an engine and a low pressure turbine driven by exhaust gas produced after driving the high pressure turbine; a low pressure compressor primarily compressing intake air by rotation of the low pressure turbine and a high pressure compressor secondarily compressing intake air by the high pressure turbine; and a compressor by-pass valve adjusting opening or closing of an intake air by-pass pipe allowing air discharged from the low pressure compressor to by-pass the high pressure compressor to move toward an intake manifold.

### CROSS-REFERENCE TO RELATED APPLICATION

This application is based on and claims the benefit of priority to Korean Patent Application No. 10-2014-0188626, filed on Dec. 24, 2014 in the Korean Intellectual Property Office, the disclosure of which is incorporated herein by reference in its entirety.

### TECHNICAL FIELD

The present disclosure relates to a two-stage turbo charger system and a method of controlling the same, and more particularly, to a two-stage turbo charger system capable of improving performance, and a method of controlling the same.

### BACKGROUND

Generally, a turbo charger drives a turbine using a pressure of exhaust gas from an engine and then pushes intake air at a pressure higher than atmospheric pressure using a torque of the turbine to increase an output. In a recent turbo charger, a high pressure turbo charger having a high pressure turbine driven by the exhaust gas from the engine and a low pressure turbo charger having a low pressure turbine driven by exhaust gas produced after driving the high pressure turbine are disposed in a channel of the exhaust gas, and the intake air is primarily compressed in a low pressure compressor of the low pressure turbo charger, is secondarily compressed in a high pressure compressor of the high pressure turbo charger, and is then supplied to the engine.

FIG. 1 is a view illustrating a two-stage turbo charger system according to the related art, and FIG. 2 is a block diagram schematically illustrating the two-stage turbo charger system according to the related art. As illustrated in FIGS. 1 and 2, the two-stage turbo charger system according to the related art is configured to include a high pressure turbine 11 driven by exhaust gas from an engine 30, a low pressure turbine driven by exhaust gas produced after driving the high pressure turbine 11, a low pressure compressor 23 primarily compressing intake air generated by rotation of the low pressure turbine 21, and a high pressure compressor 13 secondarily compressing intake air generated by rotation of the high pressure turbine 11. An intermediate pipe 40 is provided between the high pressure compressor 13 and the low pressure compressor 23 to connect the high pressure compressor 13 and the low pressure compressor 23 to each other. An exhaust air by-pass pipe 60 is provided with an electronic valve 61, acting as a turbine by-pass valve for opening the exhaust air by-pass pipe 60 in the high speed region. The intake air compressed by the high pressure compressor 13 is transferred to the engine 30 after passing a charge air cooler. The two-stage turbo charger system also includes an exhaust gas recirculation (EGR) cooler using engine coolant to reduce exhaust gas temperatures prior to recirculating the exhaust gas through the engine's intake system under control of an EGR control valve.

Generally, the two-stage turbo charger system compresses the intake air at a two-stage by the high pressure compressor 13 and the low pressure compressor 23 in a low speed region of the engine 30 to raise compression pressure. In addition, the two-stage turbo charger system drives only the low pressure compressor 23 so that two-stage compression is not conducted using an electronic waste gate valve mounted in the turbine by a restriction condition by turbo fouling in a high speed region of the engine 30. To this end, in the related art, an electronic by-pass valve and a waste gate were mounted and controlled to limit operations of the high pressure compressor 13 and the high pressure turbine 11 in the high speed region. However, the electronic by-pass valve as described above has problems that cost of an actuator for driving the electronic by-pass valve, logic configuration cost at the time of electronic control unit (ECU) mapping, and development man hours are high, and there is a risk of an electronic malfunction.

### SUMMARY

The present disclosure has been made to solve the above-mentioned problems occurring in the prior art while advantages achieved by the prior art are maintained intact.

An aspect of the present disclosure provides a two-stage turbo charger system capable of operating more logically as compared with the related art, rapidly and accurately performing a response depending on a state of an engine, and simplifying a structure through an operation by a boost pressure required by the engine, and a method of controlling the same.

According to an exemplary embodiment of the present disclosure, a two-stage turbo charger system includes: a high pressure turbine driven by exhaust gas from an engine and a low pressure turbine driven by exhaust gas produced after driving the high pressure turbine; a low pressure compressor primarily compressing intake air by rotation of the low pressure turbine and a high pressure compressor secondarily compressing intake air by rotation of the high pressure turbine; and a compressor by-pass valve adjusting opening or closing of an intake air by-pass pipe allowing air discharged from the low pressure compressor to by-pass the high pressure compressor to move toward an intake manifold.

The two-stage turbo charger system may further include: an air pressure transfer hose having one side connected to the low pressure compressor; and an actuator having one side connected to the other side of the air pressure transfer hose and the other side connected to the compressor by-pass valve. The compressor by-pass valve adjusts opening or closing of a channel by the actuator depending on an air pressure transferred from the air pressure transfer hose, and the intake air by-pass pipe is in communication with an intermediate pipe connecting the low pressure compressor and the high pressure compressor to each other.

The compressor by-pass valve may include: a shaft having one side connected to the actuator; a rod having one side rotatably connected to the shaft; and a valve cone having one side rotatably connected to the rod and the other side selectively inserted into a hole through which the intake air by-pass pipe and the intermediate pipe are in communication with each other.

The valve cone may include: an insertion part having a conical shape so as to be inserted into the hole through which the intake air by-pass pipe and the intermediate pipe are in communication with each other; and a connection part extended from the insertion part and connected to the rod.

The insertion part may protrude toward the hole so as to surface-contact an inner peripheral surface of the hole through which the intake air by-pass pipe and the intermediate pipe are in communication with each other.

The two-stage turbo charger system further include an exhaust air by-pass pipe allowing the exhaust gas from the engine to by-pass the high pressure turbine to move toward the low pressure turbine.

The two-stage turbo charger system may further include a valve opening the exhaust air by-pass pipe to allow the exhaust gas to by-pass the high pressure turbine to move to the low pressure turbine, when the engine arrives at a preset revolution per minute (RPM) or higher.

According to another exemplary embodiment of the present disclosure, a method of controlling a two-stage turbo charger system may include: supplying intake air compressed by a low pressure compressor to an intermediate pipe connected between the low pressure compressor and a high pressure compressor; adjusting a compressor by-pass valve to move the intake air supplied from the low pressure compressor toward an intake manifold through an intake air by-pass pipe by-passing the high pressure compressor, when an engine arrives at a preset RPM or higher; and opening an exhaust air by-pass pipe so that the exhaust gas by-passes a high pressure turbine to move to a low pressure turbine, when the engine arrives at the preset RPM or higher. The high pressure turbine may be driven by exhaust gas from the engine and the low pressure turbine may be driven by exhaust gas produced after driving the high pressure turbine, and the low pressure compressor primarily may compress intake air by rotation of the low pressure turbine and a high pressure compressor secondarily may compress intake air by rotation of the high pressure turbine.

The adjusting of the compressor by-pass valve may include driving an actuator depending on an air pressure of the compressed air supplied from the low pressure compressor and rotating a rod by a shaft having one side connected to the actuator, such that a valve cone positioned at a distal end of the rod selectively opens or closes the intake air by-pass pipe to adjust opening or closing of a channel by an air pressure.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a two-stage turbo charger system according to the related art.

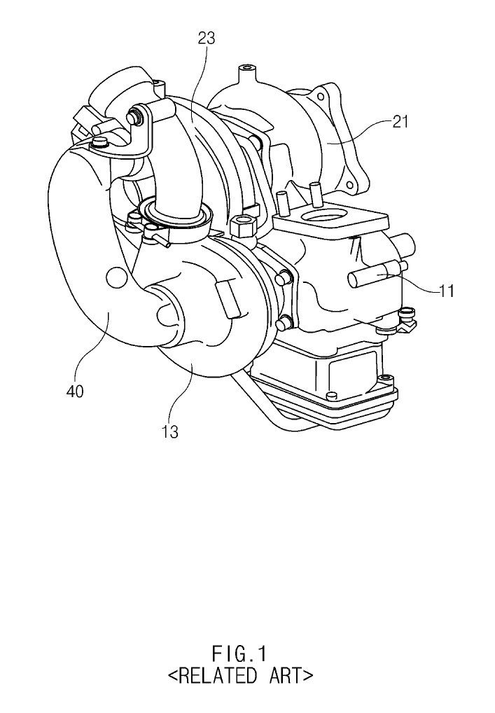

FIG. 2 is a block diagram schematically illustrating the two-stage turbo charger system according to the related art.

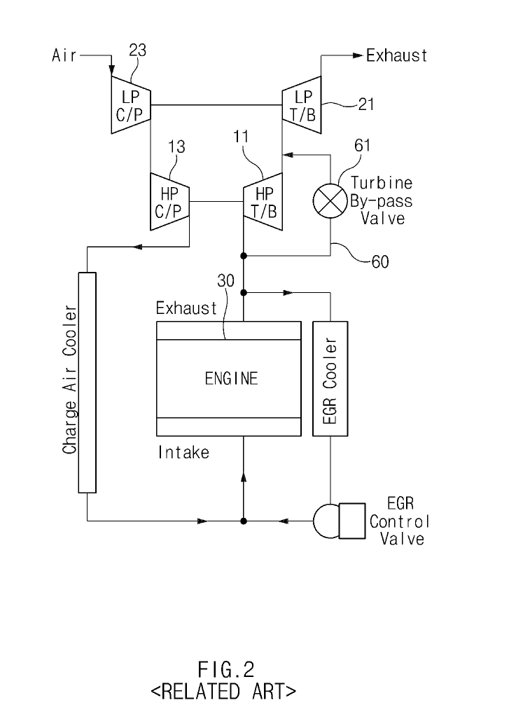

FIG. 3 is a view illustrating a two-stage turbo charger system according to an exemplary embodiment of the present disclosure.

FIG. 4 is a block diagram schematically illustrating the two-stage turbo charger system according to the exemplary embodiment of the present disclosure.

FIG. 5 is a view illustrating an opening or closing sequence of an intake air by-pass pipe of the two-stage turbo charger system according to the exemplary embodiment of the present disclosure.

FIG. 6 is a view illustrating an operation of a compressor by-pass valve for opening or closing the intake air by-pass pipe of the two-stage turbo charger system according to the exemplary embodiment of the present disclosure.

### DETAILED DESCRIPTION

Hereinafter, exemplary embodiments of the present disclosure will be described in detail with reference to the accompanying drawings. The present disclosure relates to a two-stage turbo charger system and a method of controlling the same. The two-stage turbo charger system will be described first, and the method of controlling the same will be described thereafter.

<Two-Stage Turbo Charger System>

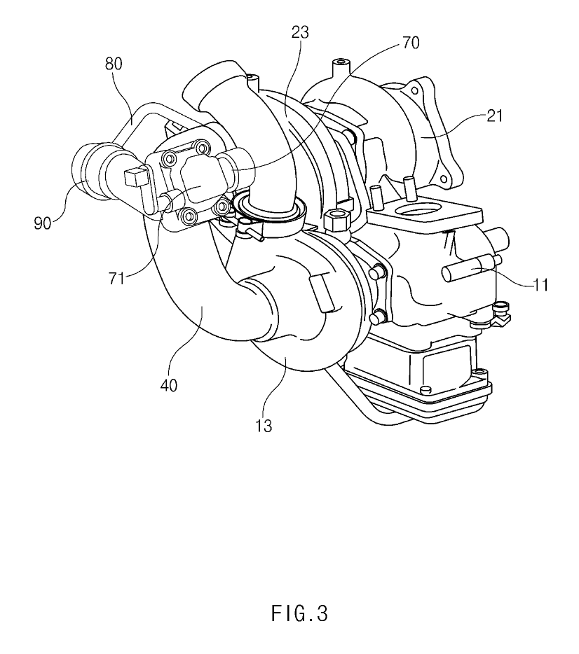

As illustrated in FIGS. 3 to 6, a two-stage turbo charger system according to an exemplary embodiment of the present disclosure is configured to include a high pressure turbine 11 driven by exhaust gas from an engine 30 and a low pressure turbine 21 driven by exhaust gas produced after driving the high pressure turbine 11; a low pressure compressor 23 primarily compressing intake air generated by rotation of the low pressure turbine 21 and a high pressure compressor 13 secondarily compressing intake air generated by rotation of the high pressure turbine 11; and a compressor by-pass valve 71 adjusting opening or closing of an intake air by-pass pipe 70 allowing air discharged from the low pressure compressor 23 to by-pass the high pressure compressor 13 to move toward an intake manifold.

An intermediate pipe 40 is provided between the high pressure compressor 13 and the low pressure compressor 23 to connect the high pressure compressor 13 and the low pressure compressor 23 to each other. Intake air primarily compressed and discharged from the low pressure compressor 23 moves in the intermediate pipe 40 and is then introduced into the high pressure compressor 13. Then, the intake air is secondarily compressed by the high pressure compressor 13.

The intake air by-pass pipe 70 is in communication with the intermediate pipe 40 to allow the intake air to by-pass the high pressure compressor 13 without moving from the low pressure compressor 23 to the high pressure compressor 13 through the intermediate pipe 40.

A compressor by-pass valve 71 is provided in the intake air by-pass pipe 70 as described above. The compressor by-pass valve 71 adjusts opening or closing of a channel by an air pressure to selectively open or close the intake air by-pass pipe 70, thereby adjusting movement of the intake air.

The compressor by-pass valve 71 adjusts the opening or the closing of the channel by the air pressure. That is, when an air pressure in the intermediate pipe 40 arrives at a preset pressure, the compressor by-pass valve 71 is operated to open the intake air by-pass pipe 70, thereby allowing the intake air to by-pass the high pressure compressor 13.

Meanwhile, in order to operate the compressor by-pass valve 71 depending on the preset pressure, an air pressure transfer hose 80 having one side connected to the low pressure compressor 23 and an actuator 90 having one side connected to the other side of the air pressure transfer hose 80 are provided. The actuator 90 is a pneumatic actuator, and has the other side connected to the compressor by-pass valve 71. Therefore, the pneumatic actuator 90 receives an air pressure of the low pressure compressor 23 transferred from the air pressure transfer hose 80, and is driven depending on the air pressure transferred from the air pressure transfer hose 80 to operate the compressor by-pass valve 71.

The intake air compressed by the high pressure compressor 13 and/or the low pressure compressor 23 is transferred to the engine 30 after passing a charge air cooler. The two-stage turbo charger system according to the exemplary embodiment of the present disclosure also includes an exhaust gas recirculation (EGR) cooler using engine coolant to reduce exhaust gas temperatures prior to recirculating the exhaust gas through the engine's intake system under control of an EGR control valve.

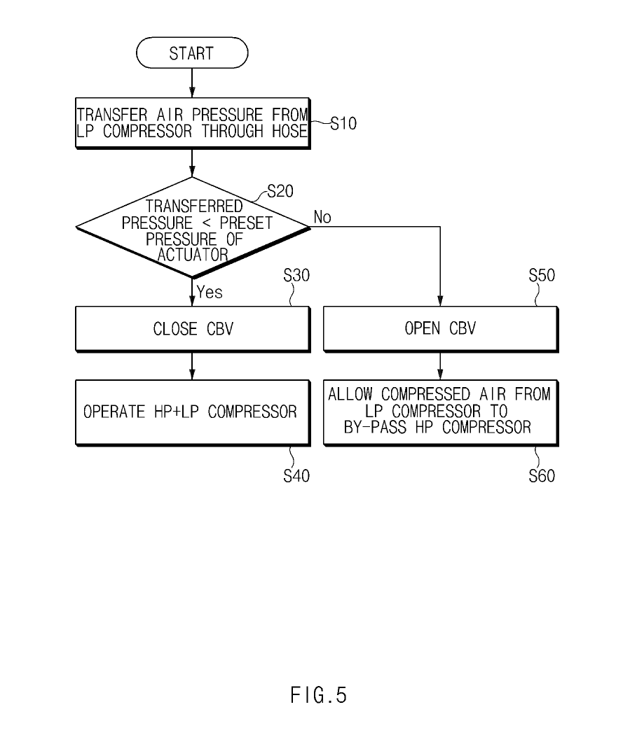

As illustrated in FIG. 5, the air pressure from the low pressure compressor 23 is transferred to the pneumatic actuator 90 through the transfer hose 80 (S10). When the engine 30 does not arrive at a preset revolution per minute (RPM), that is, in the case of a low speed region, the air pressure in the intermediate pipe 40 does not arrive at the preset pressure of the actuator 90, such that the actuator 90 is not operated (“Yes” of S20). Therefore, the compressor by-pass valve 71 connected to the actuator 90 is not operated, such that it maintains a state in which it closes the intake air by-pass pipe 70 (S30). Therefore, the intake air primarily compressed and discharged from the low pressure compressor 23 moves to the high pressure compressor 13, is secondarily compressed, and is then introduced into the engine 30 (S40).

When the engine 30 arrives at the preset RPM or higher, that is, in the case of a high speed region, the air pressure in the intermediate pipe 40 becomes the preset pressure or more of the actuator 90 (“No” of S20). Therefore, the actuator 90 is operated, and the compressor by-pass valve 71 connected to the actuator 90 opens the intake air by-pass pipe 70 (S50). Therefore, the intake air primarily compressed and discharged from the low pressure compressor 23 does not move to the high pressure compressor 13, but by-passes the high pressure compressor 13 to move toward the intake air manifold (S60).

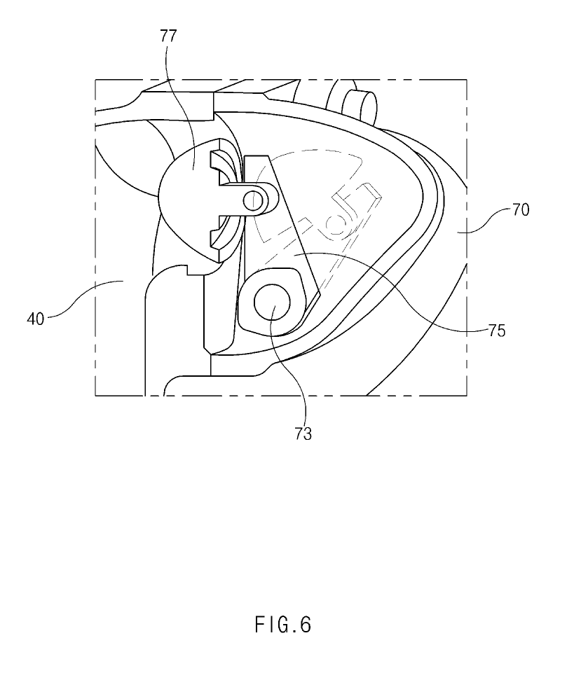

The compressor by-pass valve 71 is driven by the pneumatic actuator 90 as described above to open or close the intake air by-pass pipe 70. As illustrated in FIG. 6, the compressor by-pass valve 71 includes a shaft 73 having one side connected to the actuator 90, a rod 75 having one side rotatably connected to the shaft 73, and a valve cone 77 having one side rotatably connected to the rod 75. The valve cone 77 opens or closes the intake air by-pass pipe 70 and the intermediate pipe 40 to allow the intake air by-pass pipe 70 and the intermediate pipe 40 to be selectively in communication with each other by rotation of the rod 75. The valve cone 77 has an end portion selectively inserted into a hole through which the intake air by-pass pipe 70 and the intermediate pipe 40 are in communication with each other by the rotation of the rod 75. It is preferable that the valve cone 77 has a parabola shape so that an end portion thereof is sharp in order to improve air-tightness of the hole. That is, the valve cone 77 has the parabola shape, such that the sharp end portion blocks the intake air by-pass pipe 70 and the intermediate pipe 40 while being inserted into the hole through which the intake air by-pass pipe 70 and the intermediate pipe 40 are in communication with each other. The valve cone 77 having the shape as described above may earlier contact the hole through which the intake air by-pass pipe 70 and the intermediate pipe 40 are in communication with each other as compared with the case in which the valve cone 77 has a flat shape, thereby making it possible to prevent leakage of air to the low pressure compressor 23 at the time of closing the intake air by-pass pipe 70. In addition, the valve cone 77 is of the conical shape, thereby making it possible to suppress interference between the hole and the valve at the time of repeatedly opening or closing the hole.

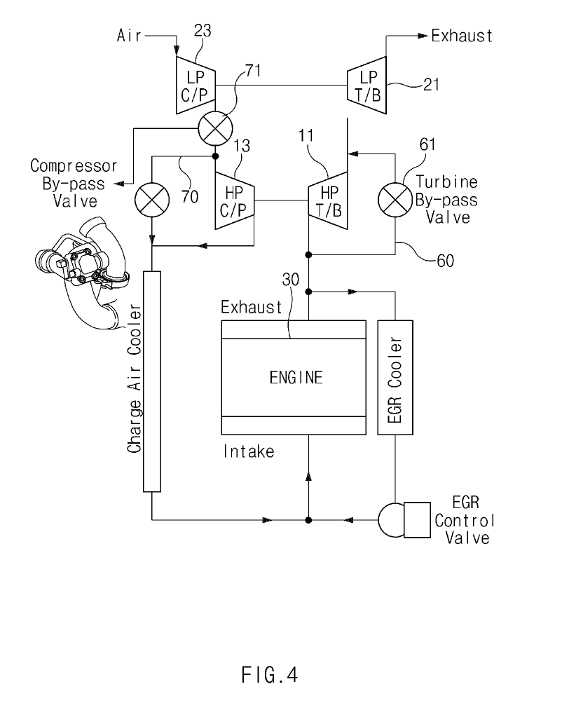

Meanwhile, an exhaust air by-pass pipe 60 allowing the exhaust gas to by-pass the high pressure turbine 11 to move toward the low pressure turbine 21 is provided on the channel of the exhaust gas from the engine 30. The exhaust air by-pass pipe 60 allows the exhaust gas to by-pass the high pressure turbine 11 to move to the low pressure turbine 21 when the engine 30 arrives at the preset RPM or higher, that is, in the high speed region. It is preferable that the exhaust air by-pass pipe 60 is provided with an electronic valve 61, acting as a turbine by-pass valve for opening the exhaust air by-pass pipe 60 in the high speed region (See FIG. 4).

As described above, the intake air by-pass pipe 70 is opened or closed together with the exhaust air by-pass pipe 60 on the channel of the exhaust gas. In the low speed region of the engine 30, the exhaust gas does not by-pass the high pressure turbine 11 along the exhaust air by-pass pipe 60, but passes through the high pressure turbine 11 and is then introduced into the low pressure turbine 21. Therefore, both of the high pressure turbine 11 and the low pressure turbine 21 rotate by the exhaust gas, and the intake air is primarily compressed in the low pressure compressor 23 and is secondarily compressed in the high pressure compressor 13, by torques of the high pressure turbine 11 and the low pressure turbine 21, and is then introduced into the engine 30. In this case, the air pressure in the intermediate pipe 40 between the low pressure compressor 23 and the high pressure compressor 13 does not arrive at the preset pressure of the actuator 90, such that the actuator 90 is not driven. Therefore, the compressor by-pass valve 71 connected to the actuator 90 maintains the state in which it closes the intake air by-pass pipe 70.

On the other hand, in the high speed region of the engine 30, the exhaust air by-pass pipe 60 is opened by the electronic valve 61. Therefore, the exhaust gas from the engine 30 by-passes the high pressure turbine 11 along the exhaust air by-pass pipe 60 to move to the low pressure turbine 21. Therefore, only the low pressure turbine 21 rotates by the exhaust gas, and the high pressure turbine 11 does not rotate.

Therefore, although the intake air is primarily compressed in the low pressure compressor 23 by the torque of the low pressure turbine 21, it is not introduced into the high pressure compressor 13 since the high pressure turbine 11 does not rotate. In this case, the air pressure in the intermediate pipe 40 between the low pressure compressor 23 and the high pressure compressor 13 arrives at the preset pressure of the actuator 90, such that the actuator 90 is driven. In addition, the compressor by-pass valve 71 connected to the actuator 90 also rotates to open a hole between the intermediate pipe 40 and the intake air by-pass pipe 70, and the intake air is not introduced into the high pressure compressor 13, but by-passes the high pressure compressor 13 along the intake air by-pass pipe 70 to move toward the low pressure compressor 23.

<Method of Controlling Two-Stage Turbo Charger System>

Next, a method of controlling a two-stage turbo charger system according to the exemplary embodiment of the present disclosure will be described.

The method of controlling a two-stage turbo charger system according to the exemplary embodiment of the present disclosure includes moving air to the high pressure compressor 13 through the low pressure compressor 23; and moving the air discharged from the low pressure compressor 23 to the intake air by-pass pipe 70 so as to by-pass the high pressure compressor 13 to thereby flow toward the intake manifold, when the engine 30 arrives at the preset RPM or higher.

In the moving of the air to the high pressure compressor 13 through the low pressure compressor 23, when the engine 30 does not arrive at the preset RPM, that is, when the engine 30 is in the low speed region, the state in which the intake air by-pass pipe 70 is closed is maintained. On the other hand, when the engine 30 arrives at the preset RPM or higher, that is, when the engine 30 is in the high speed region, the intake air by-pass pipe 70 is opened. Therefore, the air discharged from the low pressure compressor by-passes the high pressure compressor 13 along the intake air by-pass pipe 70 to move to the intake manifold.

Meanwhile, the method of controlling a two-stage turbo charger system according to the exemplary embodiment of the present disclosure further includes opening the compressor by-pass valve 71 provided in the intake air by-pass pipe 70 in order to open or close the intake air by-pass pipe 70. The compressor by-pass valve 71 adjusts the opening or the closing of the channel by the air pressure. That is, when the engine 30 does not arrive at the preset RPM, that is, in the low speed region of the engine 30, the air pressure in the intermediate pipe 40 does not arrive at the preset pressure of the actuator 90 connected to the compressor by-pass valve 71, such that the actuator 90 is not operated. Therefore, the compressor by-pass valve 71 connected to the actuator 90 does not open the intake air by-pass pipe 70. On the other hand, when the engine 30 arrive at the preset RPM, that is, in the high speed region of the engine 30, the air pressure in the intermediate pipe 40 arrives at the preset pressure of the actuator 90 connected to the compressor by-pass valve 71, such that the actuator 90 is operated. Therefore, the compressor by-pass valve 71 connected to the actuator 90 is opened to allow the air discharged from the low pressure compressor 23 to by-pass the high pressure compressor 13 to move toward the intake manifold.

Meanwhile, the method of controlling a two-stage turbo charger system according to the exemplary embodiment of the present disclosure further includes opening the exhaust air by-pass pipe 60 so that the exhaust gas by-passes the high pressure turbine 11 to move to the low pressure turbine 21 in order to open or close the intake air by-pass pipe 70 by the movement of the compressor by-pass valve 71 depending on the air pressure in the low speed region and the high speed region of the engine 30 as described above.

That is, in the low speed region of the engine 30 in which the engine 30 does not arrive at the preset RPM, the exhaust gas the engine 30 passes through the high pressure turbine 11 and is then introduced into the low pressure turbine 21. Therefore, both of the high pressure turbine 11 and the low pressure turbine 21 rotate by the exhaust gas, and the intake air is primarily compressed in the low pressure compressor 23 and is secondarily compressed in the high pressure compressor 13, by torques of the high pressure turbine 11 and the low pressure turbine 21, and is then introduced into the engine 30. In this case, the air pressure in the intermediate pipe 40 between the low pressure compressor 23 and the high pressure compressor 13 does not arrive at the preset pressure of the actuator 90, such that the actuator 90 is not driven. Therefore, the compressor by-pass valve 71 connected to the actuator 90 maintains the state in which it closes the intake air by-pass pipe 70.

On the other hand, in the high speed region of the engine 30, the exhaust air by-pass pipe 60 is opened by the electronic valve 61. Therefore, the exhaust gas from the engine 30 by-passes the high pressure turbine 11 along the exhaust air by-pass pipe 60 to move to the low pressure turbine 21. Therefore, only the low pressure turbine 21 rotates by the exhaust gas, and the high pressure turbine 11 does not rotate. Therefore, although the intake air is primarily compressed in the low pressure compressor 23 by the torque of the low pressure turbine 21, it is not introduced into the high pressure compressor 13 since the high pressure turbine 11 does not rotate. In this case, the air pressure in the intermediate pipe 40 between the low pressure compressor 23 and the high pressure compressor 13 arrives at the preset pressure of the actuator 90, such that the actuator 90 is driven. In addition, the compressor by-pass valve 71 connected to the actuator 90 also rotates to open a hole between the intermediate pipe 40 and the intake air by-pass pipe 70, and the intake air is not introduced into the high pressure compressor 13, but by-passes the high pressure compressor 13 along the intake air by-pass pipe 70 to move toward the low pressure compressor 23.

As described above, in the two-stage turbo charger system and the method of controlling the same according to the exemplary embodiments in the present disclosure, a structure may be simple, the preset pressure of the actuator may be set in accordance with the air pressure changed depending on a driving condition of the engine to improve response performance, and man hours depending on electronic control unit (ECU) mapping according to the related art may be decreased. In addition, electronic malfunction and malfunction due to abnormal mapping may be prevented, a cost required for developing logic may be decreased, and size may be decreased as compared with the related art, such that fuel efficiency may be improved. Further, generation of leakage at the time of closing the intake air by-pass pipe is prevented by the shape of the valve.

It is to be understood that the above-mentioned exemplary embodiments are illustrative rather than being restrictive in all aspects, and the scope of the present disclosure will be defined by the claims rather than the above-mentioned detained description. In addition, all modifications and alternations derived from the claims and their equivalents are to be interpreted to be included in the scope of the present disclosure.

What is claimed is:

1. A two-stage turbo charger system comprising:
a high pressure turbine driven by exhaust gas from an engine and a low pressure turbine driven by exhaust gas produced after driving the high pressure turbine;
a low pressure compressor primarily compressing intake air by rotation of the low pressure turbine and a high pressure compressor secondarily compressing intake air by rotation of the high pressure turbine; and
a compressor by-pass valve adjusting opening or closing of an intake air by-pass pipe allowing air discharged from the low pressure compressor to by-pass the high pressure compressor to move toward an intake manifold.

2. The two-stage turbo charger system according to claim 1, further comprising:
an air pressure transfer hose having one side connected to the low pressure compressor; and
an actuator having one side connected to the other side of the air pressure transfer hose and the other side connected to the compressor by-pass valve,
wherein the compressor by-pass valve adjusts opening or closing of a channel by the actuator depending on an air pressure transferred from the air pressure transfer hose, and the intake air by-pass pipe is in communication with an intermediate pipe between the low pressure compressor and the high pressure compressor.

3. The two-stage turbo charger system according to claim 2, wherein the compressor by-pass valve includes:
a shaft having one side connected to the actuator;
a rod having one side rotatably connected to the shaft; and
a valve cone having one side rotatably connected to the rod and the other side selectively inserted into a hole through which the intake air by-pass pipe and the intermediate pipe are in communication with each other.

4. The two-stage turbo charger system according to claim 3, wherein the valve cone includes:
an insertion part having a conical shape so as to be inserted into the hole through which the intake air by-pass pipe and the intermediate pipe are in communication with each other; and
a connection part extended from the insertion part and connected to the rod.

5. The two-stage turbo charger system according to claim 4, wherein the insertion part protrudes toward the hole so as to surface-contact an inner peripheral surface of the hole through which the intake air by-pass pipe and the intermediate pipe are in communication with each other.

6. The two-stage turbo charger system according to claim 1, further comprising an exhaust air by-pass pipe allowing the exhaust gas from the engine to by-pass the high pressure turbine to move toward the low pressure turbine.

7. The two-stage turbo charger system according to claim 6, further comprising a valve opening the exhaust air by-pass pipe to allow the exhaust gas to by-pass the high pressure turbine to move to the low pressure turbine, when the engine arrives at a preset revolution per minute (RPM).

8. A method of controlling a two-stage turbo charger system, the method comprising:
supplying intake air compressed by a low pressure compressor to an intermediate pipe connected between the low pressure compressor and a high pressure compressor;
adjusting a compressor by-pass valve to move the intake air supplied from the low pressure compressor toward an intake manifold through an intake air by-pass pipe by-passing the high pressure compressor , when an engine arrives at a preset RPM or higher; and
opening an exhaust air by-pass pipe so that the exhaust gas by-passes a high pressure turbine to move to a low pressure turbine, when the engine arrives at the preset RPM or higher,
wherein the high pressure turbine is driven by exhaust gas from the engine and the low pressure turbine is driven by exhaust gas produced after driving the high pressure turbine, and the low pressure compressor primarily compresses intake air by rotation of the low pressure turbine and a high pressure compressor secondarily compresses intake air by rotation of the high pressure turbine.

9. The method of claim 8, wherein the adjusting of the compressor by-pass valve comprises:
driving an actuator depending on an air pressure of the compressed air supplied from the low pressure compressor; and
rotating a rod by a shaft having one side connected to the actuator, such that a valve cone positioned at a distal end of the rod selectively opens or closes the intake air by-pass pipe to adjust opening or closing of a channel by an air pressure.
